(19) United States
(12) Patent Application Publication
(10) Pub. No.: US 2009/0151601 A1
(43) Pub. Date: Jun. 18, 2009

(54) LOW VOC WATERBASED COATINGS WITH EFFLORESCENCE RESISTANCE

(75) Inventors: Eduardus Mangnus, Deventer (NL); Selcuk Avci, Kendall Park, NJ (US)

Correspondence Address: MORGAN, LEWIS & BOCKIUS LLP, 1701 MARKET STREET, PHILADELPHIA, PA, 19103-2921, US

(73) Assignee: Elementis Specialties, Inc., Hightstown, NJ (US)

(21) Appl. No.: 12/337,405

(22) Filed: Dec. 17, 2008

Related U.S. Application Data
(60) Provisional application No. 61/014,207, filed on Dec. 17, 2007.

(51) Int. Cl. C08L 91/00

(52) U.S. Cl. 106/287.24

(57) ABSTRACT

A method to improve an efflorescence resistance of film forming compositions. The method comprises the step of adding a coalescent aid comprising a fatty acid ester to the film forming composition, the fatty acid ester has a formula of RCOOX wherein R is a hydrocarbyl having one or more aliphatic carbon-carbon double bonds, and X is selected from a group consisting of: a saturated hydrocarbyl, a hydrocarbyl having one or more aliphatic carbon-carbon double bonds and a substituted hydrocarbyl. These non volatile organic fatty acid ester based coalescents impart superior efflorescence resistance and resistance to color change to film forming compositions, including latex paints, versus conventional, VOC coalescent solvent.

### RELATED APPLICATIONS

This application claims priority to U.S. Provisional Patent Application 61/014,207, filed Dec. 17, 2007, which is herein incorporated by reference in its entirety.

### BACKGROUND

Efflorescence resistance is the ability of paint to inhibit the migration of water soluble salts from an alkaline substrate through the paint to eventually be deposited on the paint surface. When dried, the salt is observed as a white discoloration of the paint film. Various coalescent aids have been developed to resist efflorescence.

Various alcohol esters and ether alcohols have been proposed for use as coalescent aids. For example, in U.S. Pat. No. 4,131,580 Emmons et al. disclose water-based coating compositions based on vinyl addition polymers of monoethylenically unsaturated monomers which comprise dicyclopentenyl acrylate and/or dicyclopentenyl methacrylate as a coalescent aid. In U.S. Pat. No. 4,141,868, Emmons et al. suggest certain ester-ether compounds be used instead.

Two of the more widely used coalescent aids are ethylene glycol monobutyl ether (EB, Dow Chemical) and 2,2,4-trimethyl-1,3-pentanediol monobutyrate (TEXANOL®, Eastman Kodak). While EB and TEXANOL® are useful in facilitating film formation of coatings formulated with water insoluble polymers with high glass transition temperatures and are even useful in facilitating film formation of coatings with low glass transition temperatures if they are being applied at a temperature that is lower than ambient temperature, they are relatively volatile and, as a result, are currently classified as VOCs (volatile organic compounds) in the U.S.

### SUMMARY

The present invention provides for a method to improve an efflorescence resistance of film forming compositions. The method comprises the step of adding a coalescent aid comprising a fatty acid ester to the film forming composition. The fatty acid ester has a formula of RCOOX wherein R is a hydrocarbyl having one or more aliphatic carbon-carbon double bonds, and X is selected from a group consisting of: a saturated hydrocarbyl, a hydrocarbyl having one or more aliphatic carbon-carbon double bonds and a substituted hydrocarbyl.

In another embodiment, the present invention provides for a method to improve an efflorescence resistance of film forming compositions. The method comprises the step of adding a coalescent aid consisting of a fatty acid ester to the film forming composition. The fatty acid ester has a formula of RCOOX wherein R is a hydrocarbyl having one or more aliphatic carbon-carbon double bonds, and X is selected from a group consisting of: a saturated hydrocarbyl, a hydrocarbyl having one or more aliphatic carbon-carbon double bonds and a substituted hydrocarbyl.

In accordance with the methods of the present invention, the film forming system exhibits an efflorescence rating of eight or greater after 3 months exposure as determined by an efflorescence resistance test. In another embodiment, the film forming system exhibits an efflorescence rating of eight or greater after 6 months exposure as determined by an efflorescence resistance test.

In accordance with the methods of the present invention, the film forming system exhibits a ΔE value of 3 or less after 3 months exposure as determined by a color difference test. In another embodiment, the film forming system exhibits a ΔE of 4 or less after 6 months exposure as determined by a color difference test.

### DETAILED DESCRIPTION

The present invention provides for methods to improve the efflorescence resistance of film-forming compositions wherein the film forming compositions containing a coalescent aid including a fatty acid ester wherein the coalescent aid is not classified as a volatile organic compound (“VOC”) as defined herein. The present invention also provides for a method to improve the scrub resistance for such film-forming compositions, as well as improved flow and leveling, and longer open time.

Volatile Organic Compound and Volatile Organic Content

Volatile organic compounds (VOCs) are defined as those that volatilize under a given set of conditions. One set of conditions, for instance, is defined by EPA Method 24; organic matter that volatiles under the method prescribed by this test are considered volatile organic compounds. More recently, the US EPA has agreed to accept ASTM D 6886 GC Method for low VOC waterborne coatings as an alternative method for VOC determination. According to this test method, VOC may include all organic compounds up to and including TEXANOL® (boiling point=260° C.). The EU uses a similar test method, ISO Method 11890; according to this test method, compounds with boiling points below 250° C. are considered volatile organic compounds. When a compound has a boiling range that bridges the cutoff temperature, that portion that boils below the cutoff temperature is considered as VOC under both ASTM D 6886 GC Method and ISO Method 11890, the portion that boils above is not considered as VOC. In one embodiment, a volatile organic compound shall mean a compound having a boiling point of less than about 260° C. or having a boiling range ending at 260° C.

The components of the film forming composition and descriptions of exemplary coalescent aids used in the methods of the present invention are described below. For the purposes of this application, the words coalescent aid and coalescent may be used interchangeably.

Film-Forming Composition

The water-based film-forming compositions of the present invention may be formulated to function as paint, sealant, caulk, adhesive or other coating. Thus, these film-forming compositions may have a wide range of viscosities, e.g., from about 50 to about 10,000 centipoise; paints, sealants and similar coatings typically have a viscosity from about 50 to about 10,000 centipoise; caulks typically have a viscosity from about 5,000 to about 1,000,000 centipoise; and adhesives typically have a viscosity from about 50 to about 50,000 centipoise. In addition, adhesives are formulated for cohesive strength as well as good contact with the substrate upon which the film-forming composition is deposited. As used herein, a water-based film-forming polymer means a film-forming polymer which is dissolved, dispersed or emulsified in water.

The water-based film-forming compositions may contain a continuous aqueous phase and a polymeric film-forming phase. In some embodiments, the continuous aqueous phase comprises at least about 10 wt. % water with the amount of water depending upon the application. For example, in some embodiments paints, sealants and similar coating compositions have at least about 10 wt. % water and may contain about 20 wt. % to about 80 wt. % water with differing amounts being used for textured, high gloss, semi-gloss, flat, etc. coatings. In some embodiments, caulks have at least about 10 wt. % water and may contain about 10 wt. % to about 50 wt. % water with differing amounts being used for different caulk applications. In certain embodiments, adhesives range from about 10 wt. % to about 80 wt. % water and may contain about 40 wt. % to about 60 wt. % water with differing amounts being used for different adhesive applications. In some embodiments, the continuous aqueous phase of the film-forming composition may include one or more water-soluble volatile organic solvents, i.e., substituted hydrocarbon solvents. For example, in some embodiments modest amounts of ethylene glycol (e.g., 3-5 wt. %) or another glycol may be included for freeze-thaw protection. In some embodiments, the proportion of volatile organic solvents is minimized; that is, the film forming composition may contain less than about 20 wt. % volatile organic solvent, less than about 10 wt. % volatile organic solvent, or less than about 5 wt % volatile organic solvent, based upon the weight of the non-aqueous phase of the film forming composition and exclusive of any amount which may be present in a micelle or other dispersed phase or material. To meet increasingly stringent environmental regulations, the volatile organic solvent content is negligible (less than about 0.1 wt. %) in some embodiments. In some embodiments, the film forming composition has a volatile organic content of less than about 10 g/L.

In some embodiments, the dispersed phase comprises a water-based film-forming polymer and, optionally, one or more additives. In certain embodiments, the dispersed phase, including the water-based film-forming polymer, constitutes no more than about 90 wt % of the film forming composition with the amount of dispersed phase depending upon the application. In some embodiments, paints, sealants and similar coating compositions have no more than about 90 wt % dispersed phase and may contain about 20 wt % to about 80 wt % dispersed phase with differing amounts being used for textured, high gloss, semi-gloss, flat, etc. coatings. In some embodiments, caulks have no more than about 90 wt. % dispersed phase and may contain about 75 wt % to about 90 wt % dispersed phase with differing amounts being used for different caulk applications. In some embodiments, adhesives range from about 20 wt % to about 90 wt % dispersed phase and may contain about 40 wt % to about 60 wt % dispersed phase with differing amounts being used for different adhesive applications.

In some embodiments, the dispersed polymer is insoluble in the aqueous phase and is otherwise suitable for use in water borne film-forming compositions. Because in some embodiments the dispersed polymer is the component which coalesces to form the desired film, the film-forming composition may comprise at least about 10 wt %, at least about 15 wt %, and some applications at least about 20 wt % of a coalescible dispersed polymer.

According to some embodiments of the present invention, suitable dispersed polymers are generally of high molecular weight (e.g, greater than about 60,000 Daltons for a typical film-forming latex resin). For example, in some embodiments they may be either of the addition type, in particular a polymer or copolymer of one or more α,β-ethylenically unsaturated monomers, or of the condensation type, for example, a polyester or a polyamide. Suitable water-based film-forming polymers of the addition type may include the polymerization and copolymerization products of styrene, vinyl acetate, vinyl toluene, vinyl chloride, vinylidene chloride, butadiene, vinyl hydrocarbons, acrylonitrile, acrylic acid and esters thereof (hereinafter “acrylates”), and in ethacrylic acid and esters thereof (hereinafter “methacrylates”) containing monomers. Suitable condensation type water-based film-forming polymers may include epoxy, urethane, hydrocarbon, silicone, nitrocellulose, polyester, and alkyd polymers. In certain embodiments, particularly suitable water-based film-forming polymers include acrylates, methacrylates, styrene and vinyl acetate and mixtures thereof. Examples of suitable water-based film-forming polymers include the polymerizates or copolymerizates of one or more of the following: acrylates such as ethyl acrylate, butyl acrylate, 2-ethylhexyl acrylate, as well as other acrylates, methacrylates, styrene and vinyl acetate. In some embodiments, the water-based film-forming polymer comprises a latex.

In some embodiments, the film forming compositions are comprised of thermoplastic polymers; in these compositions, films may be formed upon evaporation of the water. In other embodiments, the film forming compositions are comprised of crosslinkable formulations; these formulations may be comprised of crosslinking agents and water-based film-forming polymers or self-crosslinking water-based film-forming polymers.

In some embodiments, polymers dispersed as very small particles are more readily coalesced than polymers dispersed as larger particles. Accordingly, in some embodiments, dispersed polymers have a particle size of about 3 micrometers or less. For example, for latex resins, in some embodiments approximately 90 wt % of the latex particles will have a size less than about 0.2 micrometers.

The film forming composition further comprises a coalescent aid (or solvent) which may be in the continuous phase, the dispersed phase, or partitioned between them.

In some embodiments, the coalescent aid of this invention is used in a latex system, also known as an emulsion system. In some embodiments, these coalescent aids may also find application in other systems such as those based on but not limited to alkyds, epoxies, nitrocellulose, and urethanes.

In some embodiments, the amount of coalescent aid needed to assist in film formation depends on the viscosity of the film-forming composition, the temperature at which the composition is being applied, the glass transition temperature of the film-former, and the minimum film formation temperature of the film-former. In certain embodiments, the amount of coalescent will be proportional to the amount and type of resin used with ratios in the range of about 0.1 wt % to about 50 wt % (based upon the weight of the dry resin), about 0.1 wt % to about 40 wt % (based upon the weight of the dry resin), about 0.1 wt % to about 25 wt % (based upon the weight of the dry resin), about 0.1 wt % to about 15 wt % (based upon the weight of the dry resin), about 0.1 wt % to about 10 wt % (based upon the weight of the dry resin), or in the 1 wt % to about 4 wt % range (based upon the weight of the dry resin).

As noted above, the coalescent aid may be in the continuous phase, in the dispersed phase, or partitioned between the two. In some embodiments, the predominant proportion of the fatty acid ester coalescent aid is thus dissolved in the dispersed water-based film-forming polymer. In certain embodiments, at least 80 wt %, at least 90 wt %, at least 95 wt %, or at least 99 wt % of the fatty acid ester coalescent aid is dissolved in the dispersed water-based film-forming polymer. Depending upon the type and amount of surfactants included in the film-forming composition, a fraction of the fatty acid ester coalescent aid may additionally be emulsified in the continuous aqueous phase and found in micelles along with surfactant.

The film-forming composition of the present invention may also contain various conventional additives which may be in the dispersed and/or continuous phases. Such additives may include but are not limited to thickening agents such as hydroxyethylcellulose sold by Aqualon under the trade designation Natrasol 250 and thickeners sold under the trade designation RHEOLATE® associative thickeners by Elementis Specialties, pH modifiers such as ammonium hydroxide and N,N-dimethyl ethanolamine, defoaming agents such as mineral oil or silicone oils, wetting agents such as a nonionic surfactant sold by AKZO under the trade designation Interwet 43 and a nonionic surfactant sold by Dow Chemical under the trade designation Triton X-100, algicides such as organotin compounds and tetrachloroisophthalonitrile, fungicides such as tributyl tin oxide, and 3-iodo-2-propynyl butyl carbamate, dispersants such as lecithin and an anionic dispersant sold under the trade designation Busperse 39 by Buckman, ultraviolet inhibitors such as a benztriazol UV inhibitor sold under the trade designation Tinuvin 328 by Ciba-Geigy and a hindered amine UV inhibitor sold under the trade designation by Tinuvin 123 by Ciba-Geigy, flow and leveling agents such as a polyacrylate sold under the trade designation Byk 354 by Byk-Chemie and a polysiloxane copolymer sold under the trade designation Byk 310 by Byk-Chemie, flash rust inhibitors such as an inhibitor sold under the trade designation Raybo 63 by Raybo or a barium metaborate rust inhibitor sold under the trade designation Busan 11M1 by Buckman, and freeze/thaw inhibitors such as ethylene glycol. Additional additives may include driers such as cobalt driers carboxylate salts (0.0 to 0.15 wt % Co based on the coalescent aid) and manganese driers carboxylate salts (0.0 to 0.15 wt % based on the coalescent aid), accelerators such as 1,10-phenanthroline (0 to 0.2% based on the coalescent aid) and 2,2-bipyridine (0 to 0.2% based on the coalescent aid), and anti-skinning agents such as butanone oxime (0 1 lb/100 gal formulation). When present and depending upon the application for the film-forming composition, in some embodiments these additives will not constitute more than about 10 wt % of the film-forming composition and may constitute about 3 wt % to about 10 wt % of the film-forming composition.

In some embodiments, the film forming compositions of this invention will contain pigments or dyes (ink application) to impart hiding and color to the applied film, and/or fillers such as talc, calcium carbonate, kaolin clays, etc.

The film-forming composition may be formed by conventional methods used to prepare paints, adhesives, except that the ester of the present invention is substituted, at least in part, for a conventional coalescent aid. The resulting film-forming composition may easily be applied conventionally using a brush, roller, air or airless spray or like means and requires no unusual methods of drying to form the desired film. Thus, films formed from the composition of the present invention may be dried under ambient conditions or baked at elevated temperature. Furthermore, the film-forming composition may be applied to a variety of materials.

Coalescent Aid

In one embodiment, the efflorescence resistance of a film forming composition is improved by adding a coalescent aid which is a non-volatile organic compound derived from an unsaturated fatty acid (“NON-VOC coalescent aid”). In one such embodiment, the NON-VOC coalescent aid may include an ester having the formula RCOOX wherein R is an hydrocarbyl having one or more aliphatic carbon-carbon double bonds, and X may be one or more of: a saturated hydrocarbyl, a hydrocarbyl having one or more aliphatic carbon-carbon double bonds or substituted hydrocarbyl. In another such embodiment, the NON-VOC coalescent aid may consist of an ester having the formula RCOOX wherein R is an hydrocarbyl having one or more aliphatic carbon-carbon double bonds, and X may be one or more of: a saturated hydrocarbyl, a hydrocarbyl having one or more aliphatic carbon-carbon double bonds or substituted hydrocarbyl.

In some embodiments, R contains about 9 to about 25 carbon atoms, or about 15 to about 23 carbon atoms. In some embodiments, X contains about 1 to about 30 carbon atoms, about 1 to about 18 carbon atoms, or about 1 to about 6 carbon atoms. In some embodiments, R and X in combination contain no more than about 35 carbon atoms, or no more than about 30 carbon atoms. In addition, at least one of R and X may contain a conjugated double or triple carbon-carbon bond (i.e., two or more carbon-carbon double or triple bonds which alternate with carbon-carbon single bonds). For example, the unsaturation may take the form of two conjugated double bonds, a conjugated double bond and triple bond or two conjugated triple bonds. In some embodiments, R is an unsaturated hydrocarbyl and has at least two unsaturated carbon-carbon bonds.

In one embodiment, R is derived from one or more of the following fatty acids: myristoleic acid, palmitoleic acid, linolenic acid, oleic acid, and linoleic acid. In another embodiments R is derived from a fatty acid obtained from of one or more of the following oils: soybean oil, corn oil, sunflower oil, safflower oil, canola oil, linseed oil, olive oil, rapeseed oil, palm oil, castor oil and tall oil. In yet another embodiment, R is derived from one or more of the following: corn oil, soy bean oil and tall oil.

In some embodiments, X comprises —CH₃, —C₂H₄OH, —C₂H₄OC₂H₄OH, —C₃H₆OH, or —C₃H₆OC₃H₆OH, and mixtures thereof. Exemplary coalescent aids of this embodiment are described in U.S. Pat. No. 7,160,945 which is incorporated herein by reference in its entirety.

Efflorescence Resistance, Color Difference and Scrub Resistance

The present invention provides for methods to improve the efflorescence resistance, change in color difference and/or scrub resistance of paint systems by adding NON VOC coalescent aids to film forming systems. In some embodiments, these coalescent aids may find application in paints systems such as those based on but not limited to latexes, alkyds, epoxies, nitrocellulose, and urethanes. In one embodiment, the film forming composition is a latex paint system.

The NON-VOC coalescent aids should assist in the formation of films after a polymer has been deposited onto a surface and provide improvements to the properties of the film. In one embodiment, a method of the present invention provides for a film forming systems having efflorescence resistance. The efflorescence resistance may be determined by using a test which correlates with efflorescence. Such a test is an efflorescence resistance test, as described herein, which generates an efflorescence rating. Efflorescence resistance is the ability of paint to inhibit the migration of water soluble salts from an alkaline substrate through the paint which are then deposited on the paints surface and when dried, observed as a white discoloration of the paint film. Typically a film forming composition is evaluated for this property where the composition is tinted with a contrasting color and is applied to a high alkaline test substrate. The efflorescence resistance may be measured visually and ranked from 1 to 10 with 1 being the worst and 10 being the best.

A NON VOC coalescent aid may be added to a variety of film forming systems to provide similar or improved film-forming properties and efflorescence resistance compared to film forming systems having coalescent aids which are classified as volatile organic compositions. In one such embodiment, a film forming system containing a NON VOC coalescent aid may exhibit an efflorescence rating of eight (8) or greater after 3 months exposure. In another embodiment, a film forming system containing a NON VOC coalescent aid may exhibit an efflorescence rating of eight (8) or greater after 6 months exposure. In such embodiments, the film forming system may include a latex paint system.

In another embodiment, a method of the present invention provides for a film forming system exhibiting reduced changes in color difference, upon long term exposure. Color difference may be determined by measuring the ΔE of the finished colored aqueous formulation as described herein. The color difference value is a quantitative measure of efflorescence resistance reflecting the subjective efflorescence resistance values discussed above.

In one embodiment, a NON VOC coalescent aid may be added to a variety of film forming systems to provide an improved ΔE value (a change in color through deposition of salts on a paint film) compared to coalescent aids which are classified as volatile organic compositions. In one such embodiment, a film forming system containing a NON VOC coalescent aid may exhibit a ΔE value over three months exposure of: less than about 5, less than about 4, less than about 3, or less than about 2.5. In another such embodiment, a film forming system containing a NON VOC coalescent aid may exhibit a ΔE value over six months exposure of: less than about 6, less than about 5, less than about 4, or less than about 3.5. In such embodiments, the film forming system may include a latex paint system.

Test Methods

Efflorescence Resistance

Efflorescence resistance is tested by applying a film forming system containing a coalescent aid to a surface and testing the efflorescence after set exposure times. Efflorescence resistance tests should be conducted using Cement Fiber Backerboard coated substrates coated with ¼″ Cement Block Filler and having a surface pH of approximately 12.0. The substrates should be coated with a white paint formulation containing 5 wt. % colorant, Evonik Colortrend 888 series phthalo blue and 1.3 wt. % coalescent aid. The substrates should be positioned facing directly south at an angle of 45° and exposed to the elements of Hightstown, N.J. for 3 or 6 months beginning on January through March or June. The efflorescence resistance may be ranked 1 to 10 with 1 being the worst and 10 being the best.

Color Difference Test

Color difference may be determined by measuring the ΔE of the Cement Fiber Backerboard substrate coated with a paint formulation as described in the Efflorescence Resistance section above. The values may be determined by following the procedure outlined in ASTM test method D-2244-02. Test substrates coated with a paint formulation are prepared as described above in the Efflorescence Resistance section. A color value is measured on the test substrate prior to exposure, and on a reference substrate. The difference between the color values of the test substrate and the reference substrate is ΔE¹. After 3 months, the measurements of the test substrate and the reference substrate are repeated, and the difference between test substrate and reference substrate color values at 3 months is ΔE¹¹. ΔE at three months is calculated as the difference between ΔE¹¹ and ΔE¹. Similarly, ΔE at six months is determined by calculating the difference between the test/reference substrate color value difference at 6 months and the initial test/reference substrate color value difference. The ΔE difference can be used as an indication of efflorescence resistance.

Scrub Resistance

The scrub resistance of a film forming composition containing a coalescent aid may be determined by following the procedures outlined in ASTM test method D-2486-06.

### EXAMPLES

The following examples further describe and demonstrate illustrative embodiments within the scope of the present invention. The examples are given solely for illustration and are not to be construed as limitations of this invention as many variations are possible without departing from the spirit and scope thereof.

The paint formulation of Table 1 was prepared and tested with NON VOC coalescent aids and VOC containing coalescent aids as described in the following examples. The grind process was performed for: 20-minutes on a high speed mixer (Dispermat with Cowles blade); 400 rpm. Hegman grind reading of 5+.

TABLE 1
Interior Eggshell test paint based on Ucar 625/Airflex EF 811

| Raw Material | Pounds | Supplier/Vendor | Function |
|---|---|---|---|
| Water | 206.6 | | Solvent |
| Natrosol Plus 330 | 1.5 | Hercules | Cellulosic thickener |
| Tamol 1124 | 6.0 | Rohm and Haas | Pigment dispersant |
| AMP 95 | 2.0 | Angus | Amine for pH adjustment |
| Strodex PK 90 | 2.0 | Dexter | Surfactant |
| Triton CF 10 | 2.0 | Dow | Surfactant |
| Drewplus L-475 | 1.5 | Drew Industries | Defoamer |
| Nuosept 95 | 1.5 | ISP | Bacteriocide |
| Ti-Pure R-706 | 230.0 | DuPont | Titanium dioxide |
| | | | pigment |
| Mattex | 110.0 | Englehard/BASF | Extender pigment |
| Attagel 50 | 5.0 | Englehard/BASF | Attapulgite thickener |
| Grind | | | |
| Airflex EF 811 | 209.0 | Air Products | VAE latex resin |
| UCAR 625 | 229.0 | Dow Chemical | Resin binder |
| Water | 56.0 | | Solvent |
| Drewplus L-475 | 3.0 | Drew Industries | Defoamer |
| Acrysol RM | 20.0 | Rohm and Haas | Associative thickener |
| 2020NPR | | | |
| Acrysol RM 825 | 4.0 | Rohm and Haas | |
| Coalescent | 14.0 | | |
| TOTAL | 1103.1 | | |

### Example 1

### Efflorescence of Paints Formulated with Fatty Acid Ester Coalescents

This Example details the procedure for testing of the efflorescence resistance of a latex paint over an alkaline substrate. Coatings are often applied to alkaline substrates, which are usually cementicious in nature. The coating must withstand the alkalinity of this substrate. Further, cementicious substrates efflorescence salts through the surface of the coating. Ultra Hide Blockaid (ICI Glidden Portland cement block filler) was used to simulate a highly alkaline substrate prone to efflorescence.

Testing Procedure

Efflorescence resistance studies were conducted using Cement Fiber Backerboard coated substrates coated with ¼″ Cement Block Filler and having a surface pH of approximately 12.0. The substrates were coated with the paint formulation of Table 1 containing 5 wt. % colorant, Evonik Colortrend 888 series phthalo blue, and containing 1.3 wt. % coalescent aid. The substrates were positioned facing directly south at an angle of 45° and exposed to the elements of Hightstown, N.J. for periods of 3 or 6 months beginning on Jan. 9, 2007. The paint formulations were formulated with 1.3 wt. % coalescent aid.

The coalescent aid which does not quality as a NON VOC composition was TEXANOL™, having the formula of 2,2,4-trimethyl-1,3-pentanediol monobutyrate and is a product of Eastman Chemical Co. Test paints containing one of four NON VOC coalescent aids were also examined. DAPRO® FX-513 is ester composition having a formula of RCOOX where R is an unsaturated aliphatic group and is a product of Elementis. ARCHER RC™ is a monoester of propylene glycol and polyunsaturated fatty acids and is a product of Archer Daniels Midland. LOXANOL® EFC 100 is produced from renewable raw materials and is a product of Cognis USA. OPTIFILM® 400 is a VOC free coalescent aid with a composition of di-2-ethylhexanoate ester of tripropylene glycol sold by Eastman Chemical Co.

Efflorescence Results

Efflorescence resistance is the ability of paint to inhibit the migration of water soluble salts from an alkaline substrate through the paint which are then deposited on the paints surface and when dried, observed as a white discoloration of the paint film. Typically paint is evaluated for this property tinted with a contrasting color: in this evaluation, 3% of a phthalo blue tint was added to the white base formulation of Table 1.

Visually the efflorescence of the DAPRO®FX513, ARCHER RC™, and LOXANOL® EFC 100 is significantly better than both the TEXANOL™ control and the OPTIFILM® 400 paints. Delta E values also support these observations (light color through deposition of the salts on the paint film). Results are included in Table 2.

TABLE 2
Efflorescence Resistance Over Block Aid Cement Panel

| | 3 Month | | 6 Month | |
|---|---|---|---|---|
| | Exposure | | Exposure | |
| | | Efflorescence | | Efflorescence |
| Coalescent | ΔE | Rating | ΔE | Rating |
| TEXANOL ™ | 5.61 | 7 | 5.83 | 6 |
| DAPRO ® FX513 | 2.26 | 9 | 3.25 | 9 |
| ARCHER RC ™ | 2.27 | 9 | 3.42 | 9 |
| LOXANOL ® | 2.68 | 9 | 3.64 | 8 |
| EFC 100 | | | | |
| OPTIFILM ® 400 | 7.05 | 5 | 8.73 | 4 |

Efflorescence Resistance Rating: 10 = best, 1 = worst

The test results included in Table 2 show that the paint containing NON VOC coalescent aids DAPRO® FX513, ARCHER RC™, and LOXANOL® EFC 100 exhibited higher efflorescence ratings after three month and six month exposures than the paint containing VOC coalescent aid TEXANOL™. Likewise, the DAPRO® FX513, ARCHER RC™, and LOXANOL® EFC 100 resulted in lower ΔE values of 2.26-2.68 after three month exposure compared with 5.61 for VOC TEXANOL™, and values of 3.25-3.64 after six month exposure compared with 5.83 for VOC TEXANOL™. OPTIFILM® 400 does not fit the pattern shown by the other NON VOC coalescent aids tested, as the OPTIFILM® 400 had lower efflorescence ratings and higher ΔE after three months and six months than even the VOC TEXANOL™. The results of Table 2 show that overall, the use of DAPRO® FX513, a NON VOC ester composition having a formula of RCOOX where R is an unsaturated aliphatic group, provided the best efflorescence resistance as it demonstrated the lowest ΔE values at three months and six months.

### Example 2

### Properties of Test Paints and Paint Films Using Various Coalescents

The test paints formulated with 1.3 wt. % coalescent aid were tested for wet paint properties, in order to compare the effect of the various coalescent aids before the paint is applied to a surface. The following coalescent aids were used: VOC TEXANOL™, NON VOC DAPRO® FX-513, NON VOC ARCHER RC™, NON VOC LOXANOL® EFC 100, and OPTIFILM® 400, each of which is described in the examples above. The test paints containing the various coalescent aids were tested for sag resistance, flow and leveling, gloss, low-temperature film formation for unsealed paint, and open time. The paints were also tested for block resistance at room temperature and at 120° F., and adhesion. The grind process was performed for: 20-minutes on a high speed mixer (Dispermat with Cowles blade); 4000 rpm at a Hegman grind reading of 5+. The results are included in Table 3 below.

TABLE 3
Properties of Test Paints and Paint Films Using Various Coalescents

| | 2A | 2B | 2C | 2D | 2E |
|---|---|---|---|---|---|
| Coalescent | Texanol | DAPRO | Archer RC | EFC 100 | Optifilm |
| | | FX 513 | | | 400 |
| Approximate | 47 g/L | 6 g/L | 6 g/L | 6 g/L | 6 g/L |
| VOC, Calc | | | | | |
| pH | 9.05 | 8.87 | 8.89 | 8.88 | 8.84 |
| Viscosity, KU | 99 | 107 | 108 | 108 | 98 |
| Viscosity, ICI | 1.1 | 1.5 | 1.4 | 1.5 | 1.1 |
| Sag Resistance, | 12 | 10 | 10 | 14 | 14 |
| 4-24, mils | | | | | |
| ASTM D4060 | 7 | 9 | 8 | 8 | 7 |
| Flow &Leveling | | | | | |
| Gloss 85 Degrees | 19.2 | 23.8 | 23.3 | 23.0 | 24.1 |
| Low Temperature | Pass | Pass | Pass | Pass | Pass |
| Film | | | | | |
| Formation- | | | | | |
| Unsealed | | | | | |
| Block Resistance | | | | | |
| 7 Days RT | 8 | 7 | 7 | 7 | 8 |
| 7 Days 120 F. | 5 | 4 | 4 | 4 | 5 |
| Adhesion, Gloss | | | | | |
| Alkyd, 7 Days | | | | | |
| Dry | 5B | 4B | 5B | 4B | 5B |
| Open Time, | 71 | 74 | 60 | 66 | 62 |
| minutes | | | | | |

Table 3 demonstrates that the coatings containing NON VOC coalescent aids match the wet paint properties of conventional coalescent solvents. This example demonstrates the further advantages of improved flow and leveling for a smoother finish, and longer open time, even than the prior art, conventional coalescent, which helps to improve lapping and reduce picking of the applied paint.

### Example 3

### A NON VOC Interior/Exterior Semigloss Latex Paint Based on Rhoplex HG-706 Resin

A test paint of the paint formulation in Table 4 was used in the following example.

TABLE 4
Paint Formulation

| Raw Material | Pounds | Supplier/Vendor | Function |
|---|---|---|---|
| Water | 70.9 | | Solvent |
| Kathon LX 1.5% | 1.0 | Rohm and Haas | Bacteriacide |
| Natrosol 250 MBR | 0.5 | Hercules | Thickener |
| Tamol 2001 (Dispersant) | 8.9 | Rohm and Haas | Dispersant |
| Triton CF-10 | 1.0 | Dow | Surfactant |
| BYK 024 | 1.0 | Byk Chemie | Defoamer |
| Ammonia (28%) | 1.5 | | Neutralizer |
| Ti-Pure R-706 | 225.0 | Dupont | Titanium |
| | | | dioxide |
| | | | pigment |
| Minex 10 | 20.0 | Unimin | Extender |
| | | | pigment |
| Grind | | | |
| Triton X-100 | 4.5 | Dow | Surfactant |
| Fungitrol 720 | 8.0 | ISP | Fungicide |
| HG 706 | 531.0 | Rohm and Haas | Acrylic |
| | | | emulsion resin |
| Ropaque Ultra | 30.0 | Rohm and Haas | Opacifier |
| Coalescent Solvent | 7.9 | | Coalescent |
| Propylene Glycol | 4.3 | | Antifreeze, |
| | | | wet edge |
| | | | additive |
| Water | 91.6 | | |
| Acrysol RM 2020NPR | 20.0 | Rohm and Haas | Associative |
| | | | thickener |
| Acrysol SCT 275 | 4.0 | Rohm and Haas | Associative |
| | | | thickener |
| BYK 024 | 3.0 | Byk Chemie | Defoamer |
| Water | 15.0 | | Solvent |
| TOTAL | 1049.1 | | |
| PVC - 27.5% | | | |
| VS - 34.5% | | | |

The test paint formulation of Table 4 was formulated and tested with each of the same five coalescent aids as the previous examples in order to compare the properties of the paint with each coalescent aid. The VOC levels of the test paint formulations were measured. The paint formulations were also tested for sag resistance, flow and leveling, gloss at 20 and 60 degrees, low temperature film formation for unsealed paint, block resistance, adhesion, scrub resistance and open time. The test results are included in Table 5 below.

TABLE 5
Paints and Paint Films Using Various Coalescents
LOW VOC INTERIOR EGGSHELL

| | | 3B | | | 3E |
|---|---|---|---|---|---|
| | 3A | DAPRO | 3C | 3D | Optifilm |
| Coalescent | Texanol | FX513 | Archer RC | EFC 100 | 400 |
| Approximate | 45 g/L | 20 g/L | 20 g/L | 20 g/L | 20 g/L |
| VOC, Calculated | | | | | |
| pH | 8.80 | 8.77 | 8.79 | 8.77 | 8.79 |
| Viscosity, KU | 106 | 103 | 106 | 105 | 105 |
| Viscosity, ICI | 1.1 | 1.0 | 1.0 | 1.0 | 1.0 |
| Sag Resistance, | 24+ | 16 | 20 | 18 | 24+ |
| 4-24, mils | | | | | |
| ASTM D4060 | 6 | 7 | 7 | 7 | 7 |
| Flow &Leveling | | | | | |
| Gloss 20 Degrees | 25.3 | 29.8 | 30.2 | 30.2 | 29.2 |
| Gloss 60 Degrees | 62.2 | 66.1 | 66.2 | 66.6 | 65.4 |
| Low Temperature | | | | | |
| Film Formation | | | | | |
| Unsealed | Pass | Pass | Pass | Pass | Pass |
| Block Resistance | | | | | |
| 7 Days RT | 9 | 9 | 9 | 9 | 9 |
| 7 Days 120 F. | 8 | 7 | 7 | 7 | 7 |
| Adhesion, | | | | | |
| Gloss Alkyd, | | | | | |
| 7 Days | | | | | |
| Dry | 5B | 5B | 5B | 5B | 5B |
| Scrub Resistance, | 523 | 575 | 430 | 433 | 460 |
| Cycles | | | | | |
| Open Time, | 63 | 63 | 59 | 55 | 60 |
| minutes | | | | | |

This example demonstrates that NON VOC coalescents will provide lower VOC coatings than the prior art conventional coalescent solvents, and that the block resistance of coatings formulated with these coalescents will rival those of coatings formulated with prior art, traditional VOC coalescents. The improved scrub resistance of the DAPRO FX513 indicates that films of the coating formulated with this coalescent are more abrasion resistant than those of competitive VOC coalescents and even those from paints formulated with a conventional, VOC coalescent. The DAPRO FX513 offers the further advantages of improved flow and leveling for a smoother finish, and longer open time, even than the prior art, conventional coalescent, which helps to improve lapping and reduce picking of the applied paint.

The present invention is not to be limited in scope by the specific embodiments disclosed in the examples which are intended as illustrations of a few aspects of the invention and any embodiments which are functionally equivalent are within the scope of this invention. Indeed, various modifications of the invention in addition to those shown and described herein will become apparent to those skilled in the art and are intended to fall within the appended claims.

A number of references have been cited, the entire disclosures of which are incorporated herein by reference.

1. A method to improve an efflorescence resistance of film forming compositions comprising:
adding a coalescent aid comprising a fatty acid ester to the film forming composition, said fatty acid ester having a formula of RCOOX wherein R is a hydrocarbyl having one or more aliphatic carbon-carbon double bonds, and X is selected from a group consisting of: a saturated hydrocarbyl, a hydrocarbyl having one or more aliphatic carbon-carbon double bonds and a substituted hydrocarbyl.

2. The method of claim 1, wherein the film forming system exhibits an efflorescence rating of eight or greater after 3 months exposure as determined by an efflorescence resistance test.

3. The method of claim 1, wherein the film forming system exhibits an efflorescence rating of eight or greater after 6 months exposure as determined by an efflorescence resistance test.

4. The method of claim 1, wherein the film forming system exhibits a ΔE value of 3 or less after 3 months exposure as determined by a color difference test.

5. The method of claim 1, wherein the film forming system exhibits a ΔE of 4 or less after 6 months exposure as determined by a color difference test.

6. The method of claim 1 wherein the coalescent aid comprises at least about 25 wt. % fatty acid ester.

7. The method of claim 1 wherein the coalescent aid comprises at least about 50 wt. % fatty acid ester.

8. The method of claim 1 wherein the fatty acid ester has a boiling point of above 260° C.

9. The method of claim 1 wherein the fatty acid ester is derived from one or more fatty acids of an oil of plant or animal origin and mixtures thereof.

10. The method of claim 1, wherein X comprises —C₂H₄OH, —C₂H₄OC₂H₄OH, —C₃H₆OH, or —C₃H₆OC₃H₆OH, and mixtures thereof.

11. The method of claim 9, wherein X comprises —C₂H₄OH, —C₂H₄OC₂H₄OH, —C₃H₆OH, or —C₃H₆OC₃H₆OH, and mixtures thereof.

12. The method of claim 1, wherein R has 9 to 25 carbon atoms.

13. The method of claim 1, wherein R has 15 to 23 carbon atoms.
